(19) United States
(12) Patent Application Publication
(10) Pub. No.: US 2011/0259976 A1
(43) Pub. Date: Oct. 27, 2011

(54) FUEL INJECTOR PURGE TIP STRUCTURE

(76) Inventors: Matthew Tyler, Lyons, NY (US); Jay Qian, Victor, NY (US)

(21) Appl. No.: 13/092,236

(22) Filed: Apr. 22, 2011

Related U.S. Application Data
(60) Provisional application No. 61/326,681, filed on Apr. 22, 2010.

(51) Int. Cl. F23R 3/14; B05B 7/10; F02C 7/22

(52) U.S. Cl. 239/125; 239/399

(57) ABSTRACT

Provided is a nozzle tip assembly having a radially inner annular wall and a radially outer annular wall at least partially surrounding the radially inner annular wall and forming therebetween a flow passage for routing air from an upstream end of the nozzle tip assembly to a downstream end of the nozzle tip assembly. Additionally, the nozzle tip assembly has a bleed path for bleeding air from the downstream end of the flow passage into a heat shield that surrounds a fuel delivery device that directs fuel to a plurality of spraywells.

### RELATED APPLICATIONS

This application claims the benefit of U.S. Provisional Application No. 61/326,681 filed Apr. 22, 2010, which is hereby incorporated herein by reference.

### FIELD OF INVENTION

The present invention relates generally to injectors and nozzles, and more particularly to a fuel injector and nozzle for gas turbine engines having an air flow passage.

### BACKGROUND

A gas turbine engine typically includes one or more fuel injectors for directing fuel from a manifold to a combustion chamber of a combustor. Each fuel injector typically has an inlet fitting connected either directly or via tubing to the manifold, a tubular extension or stem connected at one end to the fitting, and one or more spray nozzles connected to the other end of the stem for directing the fuel into the combustion chamber. A fuel passage (e.g., a tube or cylindrical passage) extends through the stem to supply the fuel from the inlet fitting to the nozzle. Appropriate valves and/or flow dividers can be provided to direct and control the flow of fuel through the nozzle and/or fuel passage.

### SUMMARY OF INVENTION

The present invention provides a nozzle tip assembly having a radially inner annular wall and a radially outer annular wall at least partially surrounding the radially inner annular wall and forming therebetween a flow passage for routing air from an upstream end of the nozzle tip assembly to a downstream end of the nozzle tip assembly. Additionally, the nozzle tip assembly has a bleed path for bleeding air from a downstream end of the flow passage into a heat shield that surrounds a fuel delivery device that directs fuel to a plurality of spraywells.

In particular, the nozzle tip assembly for an injector includes a radially inner annular wall defining a flow path through the nozzle tip, an annular fuel delivery device at least partially surrounding the radially inner annular wall, a radially outer annular wall at least partially surrounding the radially inner annular wall and forming therebetween a flow passage for routing air from an upstream end of the nozzle tip assembly to a downstream end of the nozzle tip assembly, and a heat shield radially outwardly surrounding a portion of the annular fuel delivery device and defining an interior air space and a plurality of spraywells extending through the heat shield for allowing fluid to flow from the annular fuel delivery device to an exterior of the heat shield, wherein the interior air space of the heat shield is connected to the flow passage, whereby a portion of the flow through the flow passage flows into the interior air space of the heat shield and around the spraywells to restrict flow of fuel from entering into the interior air space.

A downstream end of the radially outer annular wall may be configured to wrap around the annular fuel deliver device to separate the annular fuel delivery device from the flow passage.

According to another aspect of the invention, a method of providing flow in an nozzle tip assembly for an injector is provided, the nozzle tip assembly including a radially inner annular wall defining a flow path through the nozzle tip, a radially outer annular wall at least partially surrounding the radially inner annular wall and forming therebetween a flow passage, and a heat shield defining an interior air space that is connected to the flow passage. The method includes receiving at an upstream end of the flow passage at least a portion of air flow passing into an upstream end of the injector, and delivering at least a portion of the air flow in the flow passage to the interior air space, wherein the portion of the flow in the interior air space of the heat shield flows around the spraywells to restrict flow of fuel from entering into the interior air space.

The foregoing and other features of the invention are hereinafter described in greater detail with reference to the accompanying drawings.

### BRIEF DESCRIPTION OF THE DRAWINGS

FIG. 1 is a cross-sectional view of a portion of an exemplary gas turbine engine illustrating a fuel injector in communication with a combustor;

FIG. 2 is a fragmentary cross-sectional view of a fuel injector showing details of an exemplary nozzle tip assembly in accordance with the invention;

FIG. 3 is a fragmentary cross-sectional view of a fuel injector showing details of another exemplary nozzle tip assembly in accordance with the invention;

FIG. 4 is a fragmentary cross-sectional view of a fuel injector showing details of yet another exemplary nozzle tip assembly in accordance with the invention;

FIG. 5 is a cross-sectional view of a slip seal disposed in a spraywell of a heat shield assembly;

FIG. 6 is a cross-sectional view of another embodiment of a slip seal disposed in the spraywell of the heat shield assembly;

FIG. 7 is a cross-sectional view of still another embodiment of a slip seal disposed in the spraywell of the heat shield assembly; and

FIG. 8 is a cross-sectional view of yet another embodiment of a slip seal disposed in the spraywell of a heat shield assembly;

### DETAILED DESCRIPTION

The principles of the present invention have particular application to fuel injectors and nozzles for gas turbine engines and thus will be described below chiefly in this context. It will of course be appreciated, and also understood, that the principles of the invention may be useful in other applications including, in particular, other fuel nozzle applications and more generally applications where a fluid is injected by or sprayed from a nozzle.

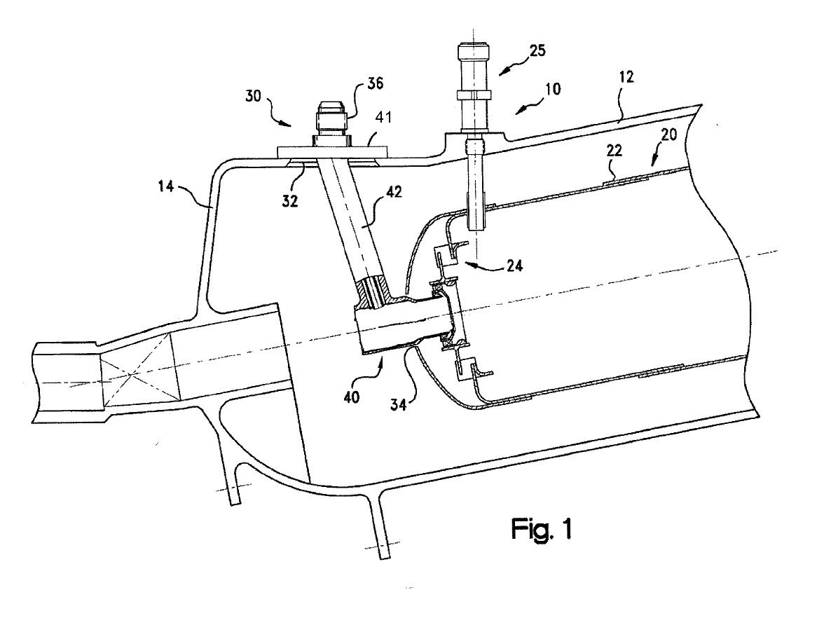

Referring now in detail to the drawings and initially to FIG. 1, a gas turbine engine for an aircraft is illustrated generally at 10. The gas turbine engine 10 includes an outer casing 12 extending forwardly of an air diffuser 14. The casing 12 and diffuser 14 enclose a combustor, indicated generally at 20, for containment of burning fuel. The combustor 20 includes a liner 22 and a combustor dome, indicated generally at 24. An igniter, indicated generally at 25, is mounted to the casing 12 and extends inwardly into the combustor 20 for igniting fuel. The above components can be conventional in the art and their manufacture and fabrication are well known.

A fuel injector, indicated generally at 30, is received within an aperture 32 formed in the engine casing 12 and extends inwardly through an aperture 34 in the combustor liner 22. The fuel injector 30 includes a fitting 36 exterior of the engine casing 12 for receiving fuel, as by connection to a fuel manifold or line; a fuel nozzle tip assembly, indicated generally at 40, disposed within the combustor 20 for dispensing fuel; and a housing 42 interconnecting and structurally supporting the nozzle tip assembly 40 with respect to fitting 36. The fuel injector 30 is suitably secured to the engine casing 12, as by means of an annular flange 44 that may be formed in one piece with the housing 42 proximate the fitting 36. The flange 41 extends radially outward from the housing 42 and includes appropriate means, such as apertures, to allow the flange 41 to be easily and securely connected to, and disconnected from, the casing 12 of the engine using, for example, bolts or rivets.

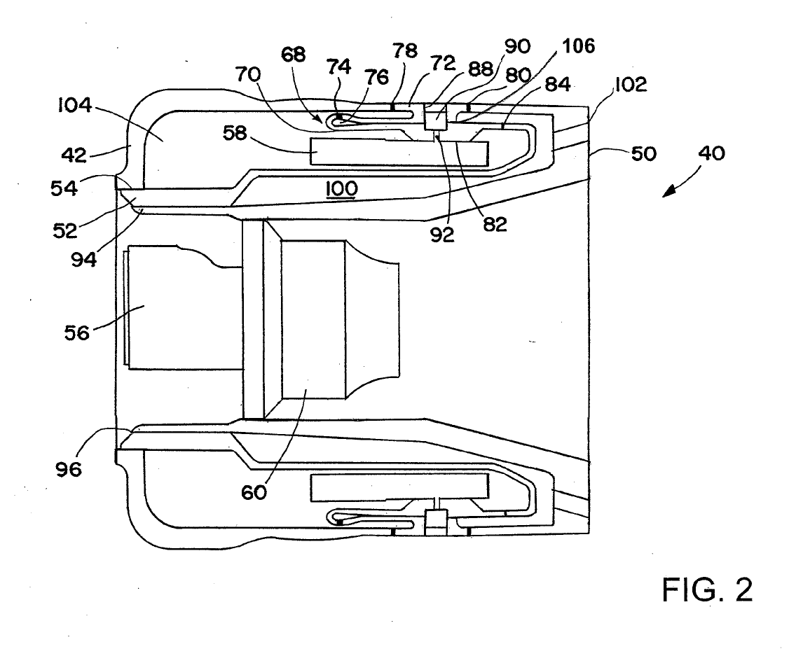

The fuel injector 30 shown in FIG. 1 is of the type disclosed in U.S. patent application Ser. No. 11/625,539 and is exemplary of a fuel injector to which principles of the invention may be applied. The nozzle tip assembly may be replaced by a nozzle tip assembly according to the present invention, and an exemplary nozzle tip assembly is shown in FIG. 2. For ease of description, the same reference numerals will be used to denote corresponding components.

Referring now to the nozzle tip assembly 40 in detail, the nozzle tip assembly 40 is configured for insertion into the fuel injector 30, and in the illustrated embodiment, at a downstream end of the housing 42. The nozzle tip assembly 40 generally includes a radially inner annular wall defining a flow path through the nozzle tip and a radially outer annular wall at least partially surrounding the radially inner annular wall and forming therebetween a flow passage for routing air from an upstream end of the nozzle tip assembly to a downstream end of the nozzle tip assembly. As shown in FIG. 2, the radially inner annular wall is formed by a shroud 50 and the radially outer annular wall is formed by an adaptor 52 that at least partially surrounds the shroud 50. The adaptor 52 is coupled to the housing 42 at an upstream end of the housing 42 by any suitable means, such as by brazing or welding at 54, or alternatively, the adaptor 52 may be integrally formed with the housing 42.

The nozzle tip assembly 40 also includes a fluid injection device 56 supported interiorly of the shroud 50. A rearward portion of the fluid injection device 56 may be coextensive with a rearward portion of the shroud 50 and the shroud 50 may radially outwardly surround the injection device 56. The fluid injection device 56 is configured to receive fluid, such as fuel, from an annular fuel delivery device 58 at least partially surrounding the shroud. The fluid injection device 56 is also configured to disperse the fuel to an air swirler 60 to be mixed with air flowing through the fuel injector 30, and the fuel flow from the fluid injection device 56 can be metered based on the engine fuel manifold pressure. The fluid injection device and associated swirler may be of any suitable design for the intended application.

The nozzle tip assembly 40 also includes an annular heat shield, such as an annular heat shield assembly 68 that includes an inner heat shield 70 and an outer heat shield 72 that are provided to shield the nozzle tip assembly from the surrounding environment. The heat shield assembly may be of any suitable design for the intended application. The heat shields 70 and 72 are coupled together at their upstream ends by any suitable means, such as by welding at 74, although it will be appreciated that the inner and outer heat shields may be unitarily formed. The inner heat shield 70 extends radially outwardly from the annular fuel delivery device 58 and an outer heat shield 72 is radially outwardly spaced form the inner heat shield 70. When coupled together, the inner and outer heat shields 70 and 72 define an interior space 76 for receiving airflow through the heat shields.

The outer heat shield 72 is configured to be coupled to the housing 42 at the downstream end of the housing by any suitable means, such as by welding at 78. The outer heat shield 72 is also configured to be coupled to a downstream end of the shroud 50 by any suitable means, such as by welding at 80. The inner heat shield 70 is configured to be coupled to the fuel delivery device 58 by any suitable means, such as by brazing at 82. As illustrated, the inner heat shield has a radially inner surface coupled to a radially outer surface of the fuel delivery device 58 by the braze 82. The inner heat shield 70 is also configured to be coupled to the adaptor 52 at a downstream end of the adaptor by any suitable means such, as by welding at 84.

The heat shields 70 and 72 include a plurality of radially outwardly extending openings forming a plurality of spraywells 88. Any suitable number of spraywells 88 may be provided and the spraywells may be radially spaced from one another in any suitable manner. Each spraywell 88 has a slip seal 90 disposed therein that is provided to limit airflow in the spraywells. The spraywells 88 and corresponding slip seals 90 are in communication with openings in the annular fuel delivery device 58 via passages 92 in the inner heat shield 70 to allow fluid that has leaked from the fuel delivery device 58 into the heat shield assembly 68 to be expelled from the nozzle assembly 40.

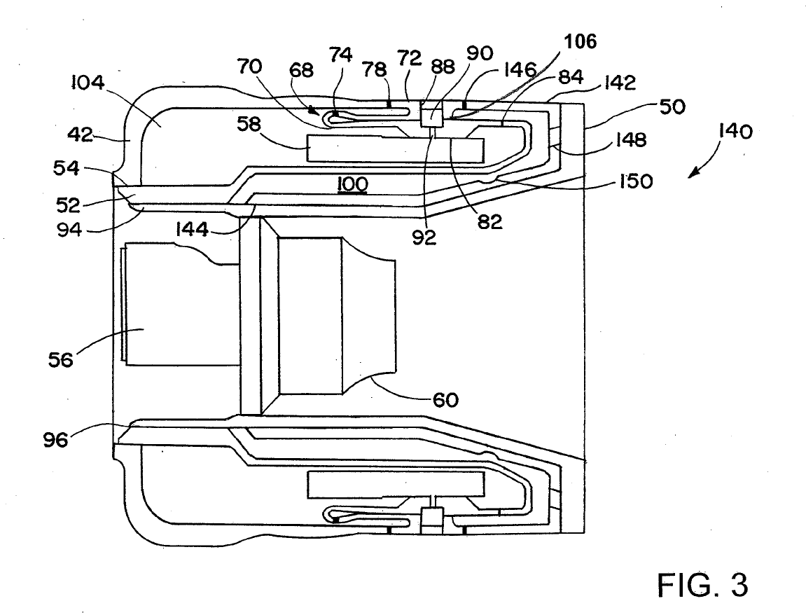

A secondary retention device may be used to provide a secondary retention feature for holding the shroud 50 to the adaptor 52 if the primary retention means, e.g. the weld at 80 (weld at 146 in FIG. 3), was to fail during use of the nozzle tip assembly. The retention device may include at least one tab on either the shroud 50 or adaptor 52 that cooperates with a ledge on the other for coupling the shroud to the nozzle adaptor. In the illustrated embodiment, the tab 94 is provided on the shroud 50 and the ledge 96 is formed on the housing adaptor 52.

As shown in FIG. 2, the above described flow passage is shown as flow passage 100, which extends between the adaptor 52 and the shroud 50 for routing air from an upstream end of the shroud to a downstream end of the shroud and to the heat shield assembly 68. As illustrated, a radially inner wall of the adaptor defines with a radially outer wall of the shroud the flow passage 100.

As air flows through the nozzle assembly 40, a portion of the air entering the nozzle tip assembly flows through the air swirler 60 and a portion of the air flows through the flow passage 100. The air that flows through the air swirler mixes with fuel from the fluid injection device 56, as described above, and the air that flows through the flow passage 100 flows towards the downstream end of the shroud 50.

A portion of the air in the flow passage 100 exits the passage via openings 102 at the distal end of the shroud to provide cooling flow through the nozzle tip assembly 40 and/or for cooling a further component located downstream of the passage 102. Another portion of the air flow is bled off to form a purge air path to provide air to the heat shield assembly 68. The purge air enters the heat shield assembly at a downstream end through a gap 106 between the inner and outer heat shields 70 and 72. The size of the gap 106 will determine the amount of flow through the heat shield assembly. Positive pressure flow of purge air at an interface between the heat shields and the spraywells is provided to minimize if not prevent backflow of fuel through the interface into the heat shields, which otherwise may damage the heat shields. The purge air flowing in the heat shield assembly 68 will exit the heat shield assembly 68 through the spraywells 88, and a portion of the air will flow into the interior space 76 and be substantially stagnant. A small gap, such as a diametrical gap, may be provided between the slip seals 90 and the spraywells 88 to control the flow from the flow passage 100.

The air that exits the heat shield assembly through the spraywells 88 allows fuel that has entered the heat shield assembly 68 from the fuel delivery device 58 to be expelled from the heat shield assembly as described above. In this way damage, such as carbon buildup between the inner and outer heat shields 70 and 72 is reduced. The flow passage 100 also prevents air flowing through the nozzle tip assembly 40 from blowing over the fuel delivery device 58. In the illustrated embodiment, the adaptor 52 wraps under and around the fuel delivery device 58 and is coupled to the inner heat shield 70 to seal off a tertiary 104, where the fuel delivery device 58 is disposed, from the flow passage 100. By preventing airflow through the nozzle from entering the tertiary 104, the fuel deliver device 58 is shielded from temperature increases caused by the air flow, thereby avoiding coking and thermal distress on the fuel delivery device.

Referring now to FIG. 3, another exemplary embodiment of a nozzle tip assembly is shown as 140. The nozzle tip assembly 140 is substantially the same as the above-referenced nozzle tip assembly 40, and consequently the same reference numerals are used to denote structures corresponding to similar structures in the nozzle tip assembly 140. In the nozzle tip assembly 140, the radially inner annular wall is formed by an aft shell 142 that surrounds the shroud and the radially outer wall is formed by the adaptor 52. Accordingly, the flow passage 100 extends between the adaptor 52 and the aft shell 142 for routing air from an upstream end of the shroud 50 and aft shell 142 to a downstream end of the aft shell and to the heat shield assembly 68. As illustrated, a radially inner wall of the adaptor defines with a radially outer wall of the aft shell the flow passage 100.

The aft shell 142 includes a radially inner wall coupled to a radially outer wall of the shroud 50 at an upstream end of the aft shell 142. The aft shell may be coupled to the shroud 50 by any suitable means, such as by brazing at 144. The aft shell 142 also has a downstream end coupled to the outer heat shield 72 by any suitable means, such as by welding at 146

As air flows through the fuel injector 30, a portion of the air flows through the air swirler 60 and a portion of the air flows through the flow passage 100. The air that flows through the air swirler mixes with fuel from the fluid injection device 56, as described above, and the air that flows through the flow passage 100 flows towards the downstream end of the aft shell 142. A portion of the air in the flow passage 100 exits the passage via openings 148 at the distal end of the aft shell 142 to provide cooling flow to a backside of the shroud 50. Another portion of the air flow is bled off to form a purge air path to the heat shield assembly 68 as described above.

The aft shell 142 also includes at least one opening 150 proximate the downstream end of the aft shell for routing air in the flow passage 100 to the radially outer wall of the shroud 50. The at least one opening 150 can be circular or elliptical holes or other shape of slots to increase flow area. The air flow provides cooling flow to the radially outer wall of the shroud 50 and also prevents a pressure drop in the flow passage 100 by relieving a pinch point as the air flows towards the heat shield assembly 68.

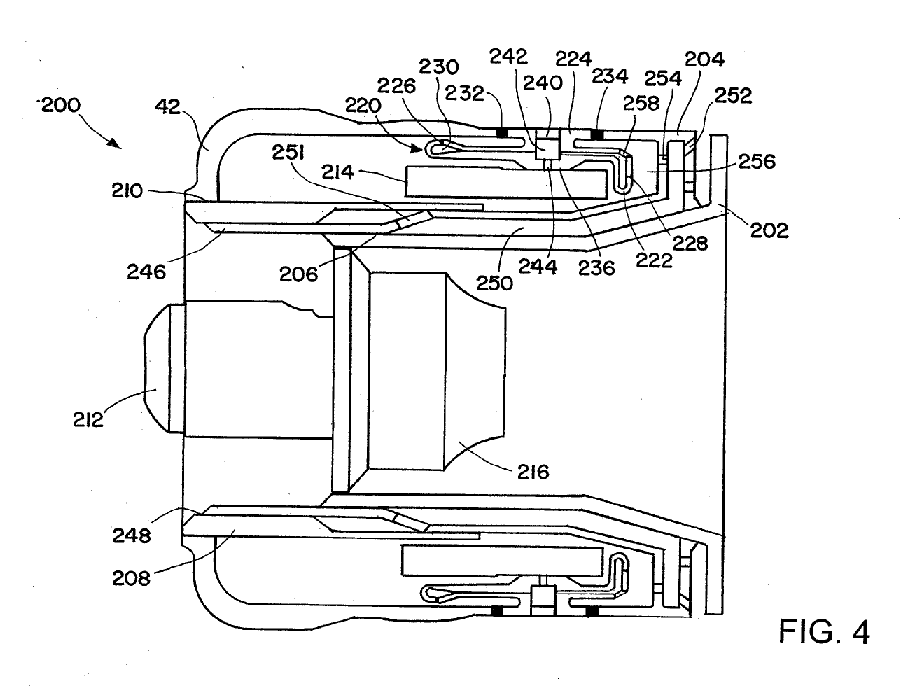

Referring now to FIG. 4 another exemplary embodiment of a nozzle tip assembly is indicated generally by reference numeral 200. The nozzle tip assembly 200 is configured for insertion into the fuel injector 30, and in the illustrated embodiment, at a downstream end of the housing 42. The nozzle tip assembly 200 generally includes a radially inner annular wall defining a flow path through the nozzle tip and a radially outer annular wall at least partially surrounding the radially inner annular wall and forming therebetween a flow passage for routing air from an upstream end of the nozzle tip assembly to a downstream end of the nozzle tip assembly. As shown in FIG. 4, the radially inner annular wall is formed by a shroud 202 and the radially outer wall is formed by an aft shell 204 surrounding the shroud. The aft shell 204 has a radially inner wall coupled to a radially outer wall of the shroud 202 at an upstream end of the aft shell 204 and may be coupled to the shroud 202 by any suitable means, such as by brazing at 206.

The nozzle tip assembly also includes an adaptor 208 that at least partially surrounds the shroud 202 and aft shell 204. The adaptor 208 is coupled to the housing 42 at an upstream end of the housing 42 by any suitable means, such as by brazing or welding at 210, or alternatively, the adaptor 208 may be integrally formed with the housing 42.

The nozzle tip assembly 200 further includes a fluid injection device 212 supported interiorly of the shroud 202. A rearward portion of the fluid injection device 212 may be coextensive with a rearward portion of the shroud 202 and the shroud 202 may radially outwardly surround the injection device 212. The fluid injection device 212 is configured to receive fluid, such as fuel, from an annular fuel delivery device 214 at least partially surrounding the shroud. The fluid injection device 212 is also configured to disperse the fuel to an air swirler 216 to be mixed with air flowing through the fuel injector 30, and the fuel flow from the fluid injection device 212 can be metered based on the engine fuel manifold pressure. The fluid injection device and associated swirler may be of any suitable design for the intended application.

The nozzle tip assembly 200 additionally includes an annular heat shield, such as an annular heat shield assembly 220 that includes an inner heat shield 222 and an outer heat shield 224 that are provided to shield the nozzle tip assembly from the surrounding environment. The heat shield assembly may be of any suitable design for the intended application. The heat shields 222 and 224 are coupled together at their upstream and downstream ends by any suitable means, such as by welding at 226 and 228, respectively, although it will be appreciated that the inner and outer heat shields may be unitarily formed. The inner heat shield 222 extends radially outwardly from the annular fuel delivery device 214 and an outer heat shield 224 is radially outwardly spaced form the inner heat shield 222. When coupled together, the inner and outer heat shields 222 and 224 define an interior space 230 for receiving airflow through the heat shields.

The outer heat shield 224 is configured to be coupled to the housing 42 at the downstream end of the housing by any suitable means, such as by welding at 232. The outer heat shield 224 is also configured to be coupled to a downstream end of the aft shell 204 by any suitable means, such as by welding at 234. The inner heat shield 222 is configured to be coupled to the fuel delivery device 214 by any suitable means, such as by brazing at 236. As illustrated, the inner heat shield has a radially inner surface coupled to a radially outer surface of the fuel delivery device 214 by the braze 236.

The heat shields 222 and 224 include a plurality of radially outwardly extending openings forming a plurality of spraywells 240. Any suitable number of spraywells 240 may be provided and the spraywells may be radially spaced from one another in any suitable manner. Each spraywell 240 has a slip seal 242 disposed therein that is provided to limit airflow in the spraywells. The spraywells 240 and corresponding slip seals 242 are in communication with the annular fuel delivery device 214 via passages 244 in the inner heat shield 222 to allow fluid that has leaked from the fuel delivery device 214 into the heat shield assembly 220 to be expelled from the nozzle assembly 200.

A secondary retention device may be used to provide a secondary retention feature for holding the shroud 202 to the adaptor 208 if the primary retention means, e.g. the weld at 234, was to fail during use of the nozzle tip assembly. The retention device may include at least one tab on either the shroud 202 or adaptor 208 that cooperates with a ledge on the other for coupling the shroud to the nozzle adaptor. In the illustrated embodiment, the tab 246 is provided on the shroud 202 and the ledge 248 is formed on the housing adaptor 208.

As shown in FIG. 4, the above described flow passage is shown as flow passage 250, which extends between the shroud 202 and the aft shell 204 for routing air from an upstream end of the shroud to a downstream end of the shroud and to the heat shield assembly 220. As illustrated, a radially inner wall of the aft shell 204 defines with a radially outer wall of the shroud 202 the flow passage 250.

As air flows through the nozzle injector assembly 40, a portion of the air entering the nozzle tip assembly flows through the air swirler 216 and a portion of the air flows through the flow passage 250 via openings 251 in the aft shell 204. The air that flows through the air swirler 216 mixes with fuel from the fluid injection device 212, as described above, and the air that flows through the flow passage 250 flows towards the downstream end of the shroud 202.

A portion of the air in the flow passage 250 exits the passage via openings 252 at the distal end of the aft shell 204 to provide cooling flow to a backside of the shroud 202. Another portion of the air exits the passage 250 via openings 254 proximate the openings 252 at the distal end of the aft shell. The air exiting the passage 250 via openings 254 flows through the openings 254 into a tertiary 256 of the nozzle tip assembly 200. The air then flows through the tertiary 256 to the downstream end of the heat shield assembly 220 and enters the heat shield assembly through openings 258 in the outer heat shield 224. It will be appreciated, however, that the openings 258 may be in the inner heat shield 222 or openings may be included in both the inner and outer heat shields. The openings 254 may be sized to provide a desired purge flow through the tertiary 256 and the openings 258 may be sized to determine how much air in the tertiary will flow to the heat shields. By allowing air to flow into the tertiary only through openings 254 and by providing openings 258 for the air to flow towards, the air in the tertiary that does not enter the heat shield assembly will be substantially stagnant. Accordingly, the fuel delivery device 214 is substantially shielded from temperature increases caused by the air flow, thereby avoiding coking and thermal distress on the fuel delivery device.

Positive pressure flow of purge air at an interface between the heat shields and the spraywells is provided to minimize if not prevent backflow of fuel through the interface into the heat shields which otherwise may damage the heat shields. The purge air flowing in the heat shield assembly 220 will exit the heat shield assembly 220 through the spraywells 240, and a portion of the air will flow into the interior space 230 and be substantially stagnant. The air that exits the heat shield assembly 220 through the spraywells 240 allows fuel that has entered the heat shield assembly 220 from the fuel delivery device 214 to be expelled from the heat shield assembly, as described above. In this way, carbon buildup between the inner and outer heat shields 222 and 224 is reduced. A small gap, such as a diametrical gap, may be provided between the slip seals 242 and the spraywells 240 to control the flow from the flow passage 250.

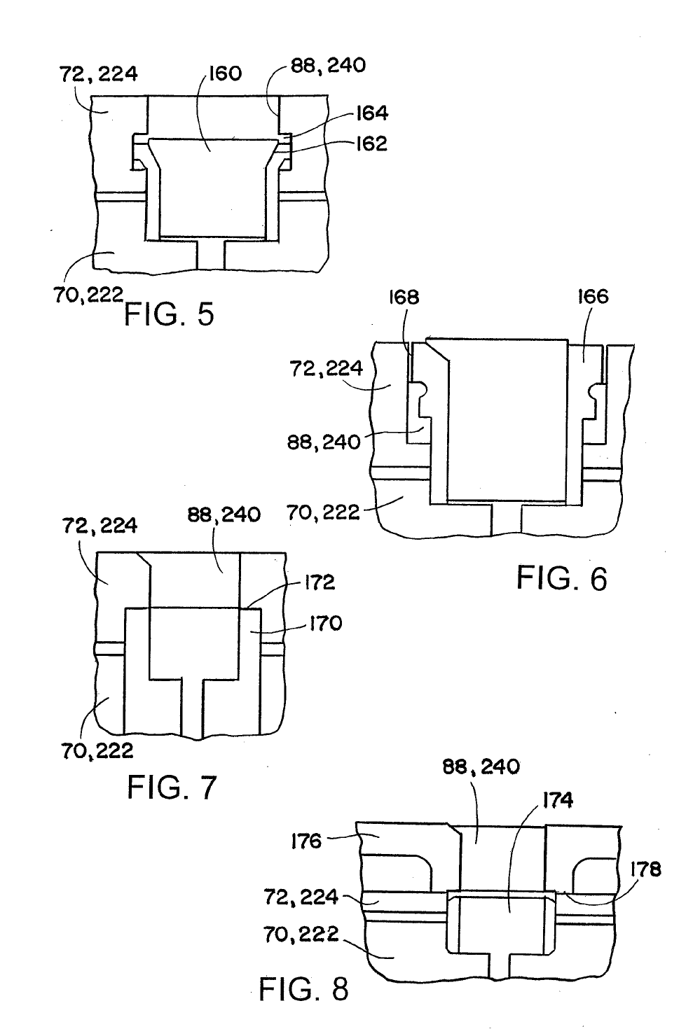

Referring now to FIGS. 5-8, four exemplary embodiments of slip seals configured to be disposed in the spraywells in nozzle tip assemblies 40, 140 and 200 are shown. It will be appreciated, however, that various other slip seal embodiments may be used without deviating from the spirit of the design.

Turning now to FIG. 5, a cross-sectional view of a slip seal 160 disposed in the spraywell 88, 240 is shown. To secure the slip seal 160 in the spraywell 88, 240, the slip seal 160 includes an upper portion 162 that is deformable outward from the slip seal. When deformed, the upper portion of the slip seal is secured in a groove 164 in the outer heat shield assembly 72, 244.

Turning now to FIG. 6, a cross-sectional view of slip seal 166 disposed in the spraywell 88, 240 is shown. To secure the slip seal 166 in the spraywell 88, 240, the slip seal may be brazed, welded, etc. to the spraywell at 168.

Turning now to FIG. 7, a cross-sectional view of slip seal 170 disposed in the spraywell 88, 240 is shown. To secure the slip seal 170 in the spraywell 88, 240, the slip seal 170 is trapped in-between the inner heat shield 70, 222 and a shoulder 172 in the outer heat shield 72, 224. After the slip seal is secured in the spraywell 88, 240, the slip seal is machined as desired.

Turning now to FIG. 8, a cross-sectional view of slip seal 174 disposed in the spraywell 88, 240 is shown. To secure the slip seal 174 in the spraywell 88, 240, an outer shell 176 is provided that traps the slip seal in-between the inner heat shield 70, 222, the outer heat shield 72, 224 and the outer shell 176. The outer shell 176 may be secured to the outer heat shield 72, 224 by any suitable means, such as by brazing at 178.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A nozzle tip assembly for an injector including:
a radially inner annular wall defining a flow path through the nozzle tip;
an annular fuel delivery device at least partially surrounding the radially inner annular wall;
a radially outer annular wall at least partially surrounding the radially inner annular wall and forming therebetween a flow passage for routing air from an upstream end of the nozzle tip assembly to a downstream end of the nozzle tip assembly; and
a heat shield radially outwardly surrounding a portion of the annular fuel delivery device and defining an interior air space and a plurality of spraywells extending through the heat shield for allowing fluid to flow from the annular fuel delivery device to an exterior of the heat shield;
wherein the interior air space of the heat shield is connected to the flow passage, whereby a portion of the flow through the flow passage flows into the interior air space of the heat shield and around the spraywells to restrict flow of fuel from entering into the interior air space.

2. A nozzle tip assembly according to claim 1, wherein the heat shield includes an inner heat shield and an outer heat shield radially outwardly spaced from the inner heat shield.

3. A nozzle tip assembly according to claim 2, wherein a downstream end of the radially outer annular wall is coupled to a downstream end of the inner heat shield.

4. A nozzle tip assembly for an injector according to claim 3, wherein the downstream end of the radially outer annular wall is configured to wrap around the annular fuel delivery device to separate the annular fuel delivery device from the flow passage.

5. A nozzle tip assembly according to claim 2, wherein a downstream end of the radially inner annular wall is coupled to a downstream end of the outer heat shield.

6. A nozzle tip assembly according to claim 1, wherein an upstream end of the radially inner annular wall is coupled to an upstream end of the radially outer annular wall.

7. A nozzle tip assembly according to claim 1, wherein a slip seal is disposed in each spraywell, the slip seals being configured to limit air flow in the spraywells.

8. A nozzle tip assembly for an injector according to claim 1, wherein a radially outer surface of the annular fuel delivery device is coupled to a radially inner surface of the heat shield.

9. A nozzle tip assembly according to claim 1, wherein the radially inner wall is formed by a shroud and the radially outer wall is formed by an adaptor.

10. A nozzle tip assembly according to claim 1, wherein the radially inner wall is formed by an aft shell and the radially outer wall is formed by an adaptor.

11. A nozzle tip assembly according to claim 10, further comprising a shroud disposed interiorly of the aft shell.

12. A nozzle tip assembly according to claim 11, wherein a radially inner wall of the aft shell is coupled to a radially outer wall of the shroud.

13. A nozzle tip assembly according to claim 11, wherein the aft shell includes at least one opening at a downstream end for routing air in the flow passage to a backside of the shroud.

14. A nozzle tip assembly according to claim 11, wherein the aft shell includes at least one opening proximate a downstream end of the aft shell for routing air in the flow passage to a radially outer wall of the shroud and for preventing pressure drop in flow passage.

15. A nozzle tip assembly according to claim 1, wherein the radially inner wall is formed by a shroud and the radially outer wall is formed by an aft shell.

16. A nozzle tip assembly according to claim 15, wherein the aft shell includes at least one opening proximate a downstream end of the aft shell for connecting the interior air space of the heat shield to the flow passage.

17. A nozzle tip assembly according to claim 1, further including an injection device supported interiorly of the radially inner annular wall.

18. An injector including a housing in which the nozzle tip assembly according to claim 1 is assembled.

19. A method of providing flow in a nozzle tip assembly for an injector, the nozzle tip assembly including a radially inner annular wall defining a flow path through the nozzle tip, a radially outer annular wall at least partially surrounding the radially inner annular wall and forming therebetween a flow passage, and a heat shield defining an interior air space that is connected to the flow passage, the method including:
receiving at an upstream end of the flow passage at least a portion of air flow passing into an upstream end of the injector; and
delivering at least a portion of the air flow in the flow passage to the interior air space;
wherein the portion of the flow in the interior air space of the heat shield flows around the spraywells to restrict flow of fuel from entering into the interior air space.

20. The method according to claim 19, wherein a portion of the air flow in the flow passage exits the flow passage via at least one opening at a downstream end of the radially inner annular wall.
